(19) United States
(12) Patent Application Publication
(10) Pub. No.: US 2014/0125077 A1
(43) Pub. Date: May 8, 2014

(54) PORTABLE MEDIA DEVICE HOLDER

(71) Applicant: Franklin Harvey, Knightdale, NC (US)

(72) Inventor: Franklin Harvey, Knightdale, NC (US)

(21) Appl. No.: 13/671,624

(22) Filed: Nov. 8, 2012

(51) Int. Cl. F16M 13/04

(52) U.S. Cl. CPC F16M 13/04
USPC 294/165

(57) ABSTRACT

A portable media device holder has a mounting plate with corner mounting brackets to hold a portable media device such as a smart phone or tablet computer. A ball joint is used to connect the mounting plate to a forearm mounting portion that enables the user to position the device at a selected angle. A hook and loop fastening strap is used to releasably hold the forearm mounting portion to the user's forearm. A handle projects downward from the forearm mounting portion that allows a user to hold and control the portable media device holder. In one embodiment, a plurality of cooling holes are provided to enable the device to operate at a cooler temperature. Additionally, breathing holes may be provided to make the forearm mounting portion more comfortable to wear. The forearm mounting portion may be padded for additional comfort.

### BACKGROUND OF THE INVENTION

In the electronic age, there are over 6 billion cell phones alone in the world and there are more cell phones in the United States than there are people. The growth of personal digital devices including tablet computers are continuing to rise and it is estimated that as many as one third of the US population will own one by 2014. Tablet computers are finding their way in many aspects of modern life including applications where the user needs to input data, search and otherwise interact with the personal media device (PMD). Of course the usefulness of these devices is greatly increased by being able to connect to the internet to access the World Wide Web, as well as other networks.

In many applications, it is difficult to interact with the tablet computer while performing other tasks since the user is required to hold the PMD with one hand. There is a need for a device that allows a user to interact with the PMD while still allowing the user the use of the hand.

### SUMMARY OF THE INVENTION

A portable media device holder has a mounting plate with corner mounting brackets to hold a portable media device such as a smart phone or tablet computer. A ball joint is used to connect the mounting plate to a forearm mounting portion that enables the user to position the device at a selected angle. A hook and loop fastening strap is used to releasably hold the forearm mounting portion to the user's forearm. A handle projects downward from the forearm mounting portion that allows a user to hold and control the portable media device holder. In one embodiment, a plurality of cooling holes are provided to enable the device to operate at a cooler temperature. Additionally, breathing holes may be provided to make the forearm mounting portion more comfortable to wear. The forearm mounting portion may be padded for additional comfort.

Other features and advantages of the instant invention will become apparent from the following description of the invention which refers to the accompanying drawings.

### BRIEF DESCRIPTION OF THE DRAWINGS

FIG. 1 is a perspective view of a portable media device holder according to an embodiment of the invention.

FIG. 2 is a perspective view of the portable media device holder show in FIG. 1 with a portable media device attached therein.

FIG. 3 is a side view of the portable media device holder shown in FIG. 1.

FIG. 4 is a bottom view of the portable media device holder shown in FIG. 1.

FIG. 5 is a perspective view of the portable media device holder shown in FIG. 1 with a plurality of cooling holes therein.

FIG. 6 is a perspective view of a right-handed embodiment of a portable media device holder according to an embodiment of the invention.

FIG. 7 is a perspective view of a left-handed embodiment of a portable media device holder.

FIG. 8 is a perspective view of the portable media device holder shown in FIG. 1 with a securing strap.

FIG. 9A is a rear view of a mounting plate utilizing a locking attachment plate to attach to a portable media device according to an embodiment of the invention.

FIG. 9B is a rear view of a different size mounting plate utilizing the locking attachment plate to connect therein.

FIG. 10 is a side view of a portable media device holder with a removable mounting plate according to an embodiment of the invention.

FIG. 11 is a perspective view of the portable media device holder shown in FIG. 1 with positioning handles.

FIG. 12 is a perspective view of the portable device holder shown in FIG. 1 with a forearm securing portion.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

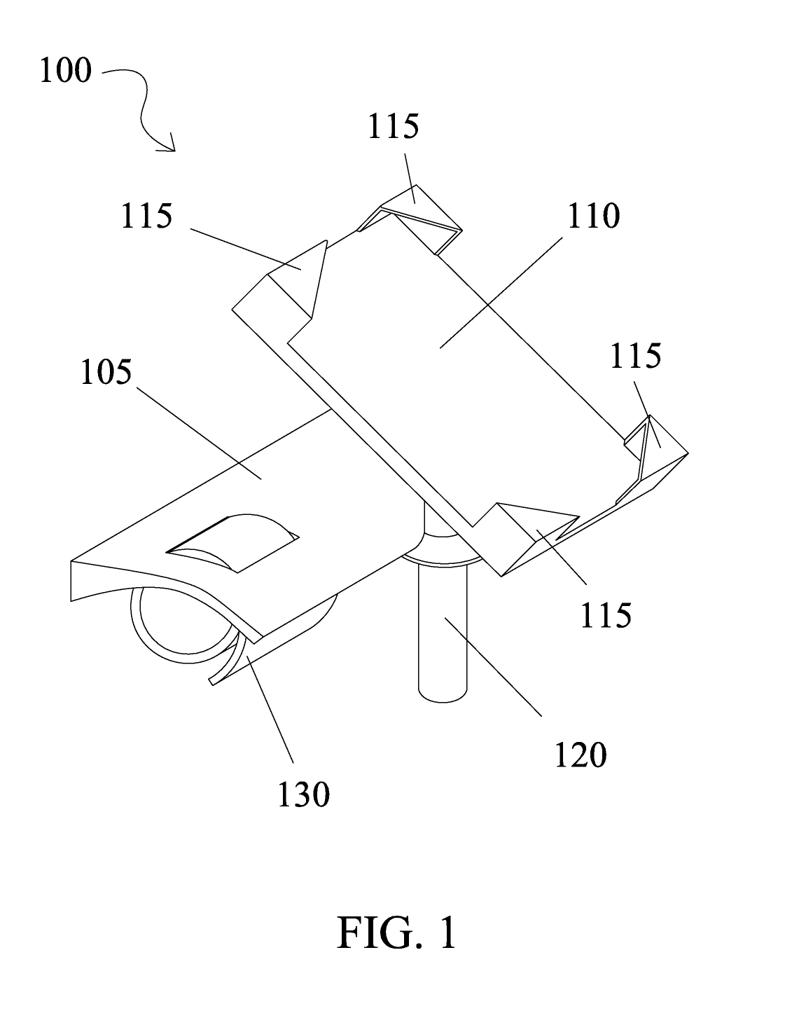

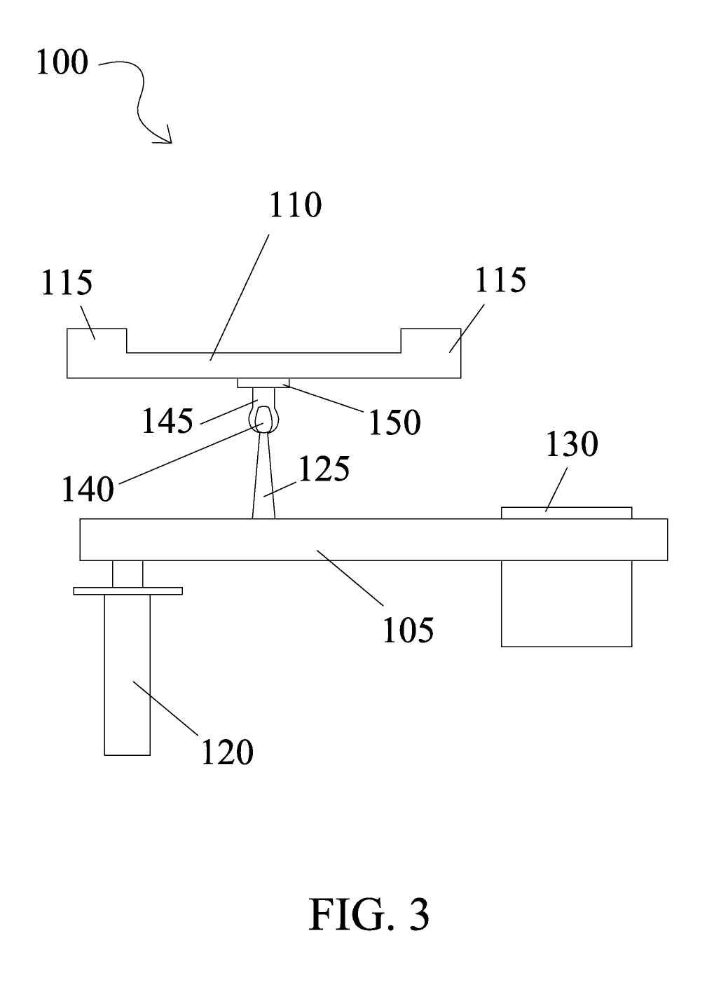

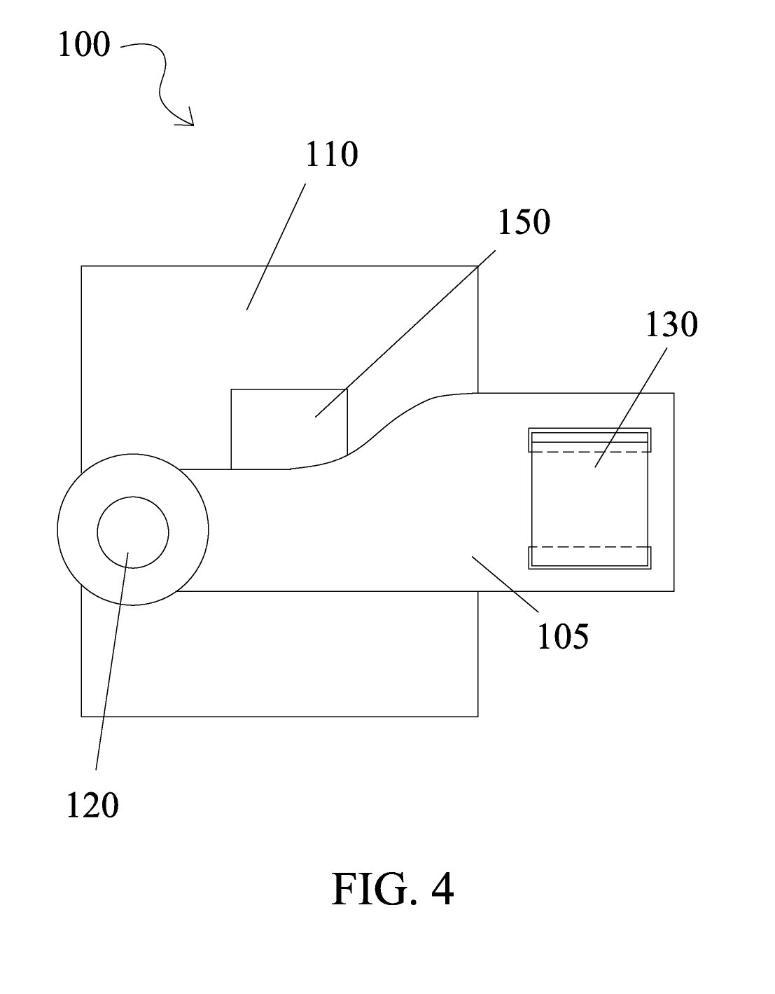

Referring to FIGS. 1 through 4 and 7, a portable media device holder 100 is shown having a forearm mounting portion 105 that fits over a user's arm (not shown) and is attached to the user's forearm with an arm strap 130. Arm strap 130 is adjustable by using a hook and loop portion that allows the user to comfortably tighten arm strap 130. Of course other adjustment methods may be used such as, but not limited to, elastic band, hooks, buckles, snaps, etc. as long as the user can adjust the strap to fit.

A mount pivot post 125 is attached to forearm mounting portion 105 and has a ball joint 140 on an end. A ball joint cage post is disposed on an attachment plate 150 on the bottom of a mounting plate 110. This allows mounting plate 110 to be positioned in an almost infinite number of positions that best suit the user's needs. The user holds on to a handle 120 that projects downward from forearm mounting portion 105. Handle 120 is covered in a resilient coating to make it comfortable to hold. Of course other coatings may be used and even no coating. Alternatively, handle 120 may be made of plastic or other material that is comfortable without the need for any coating.

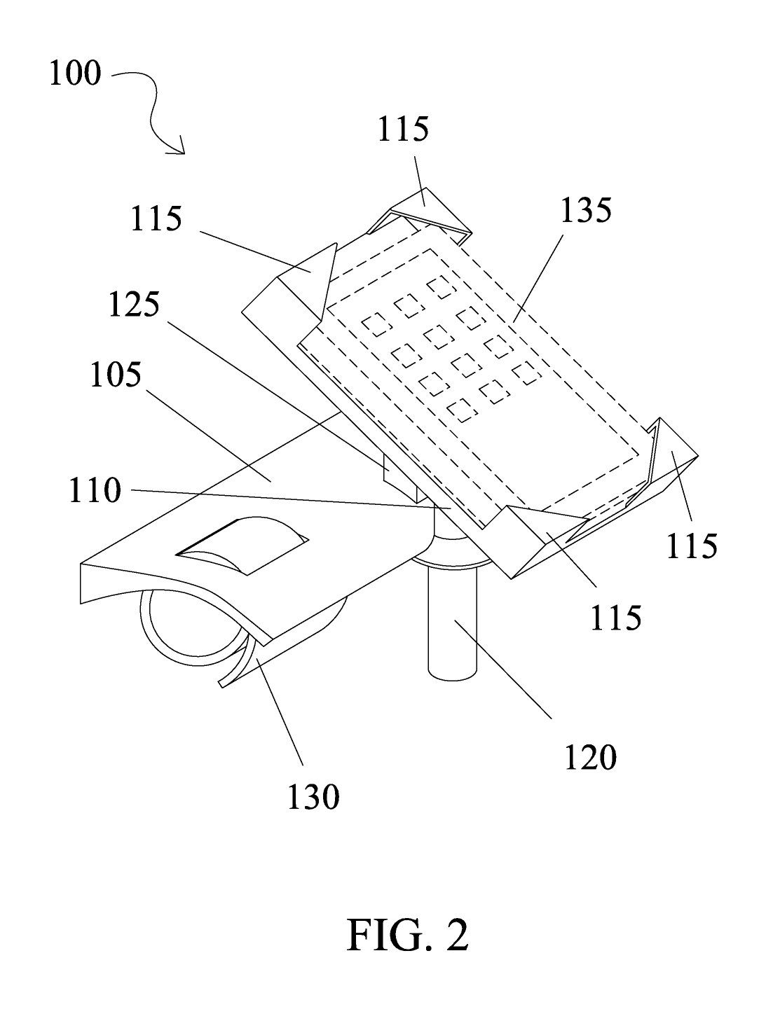

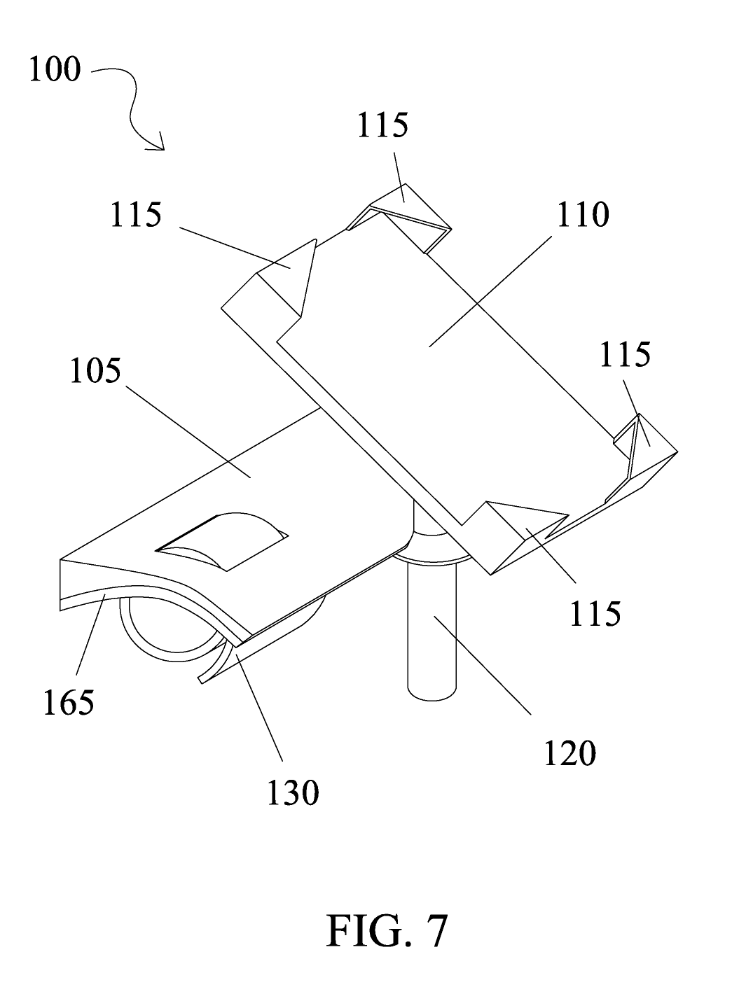

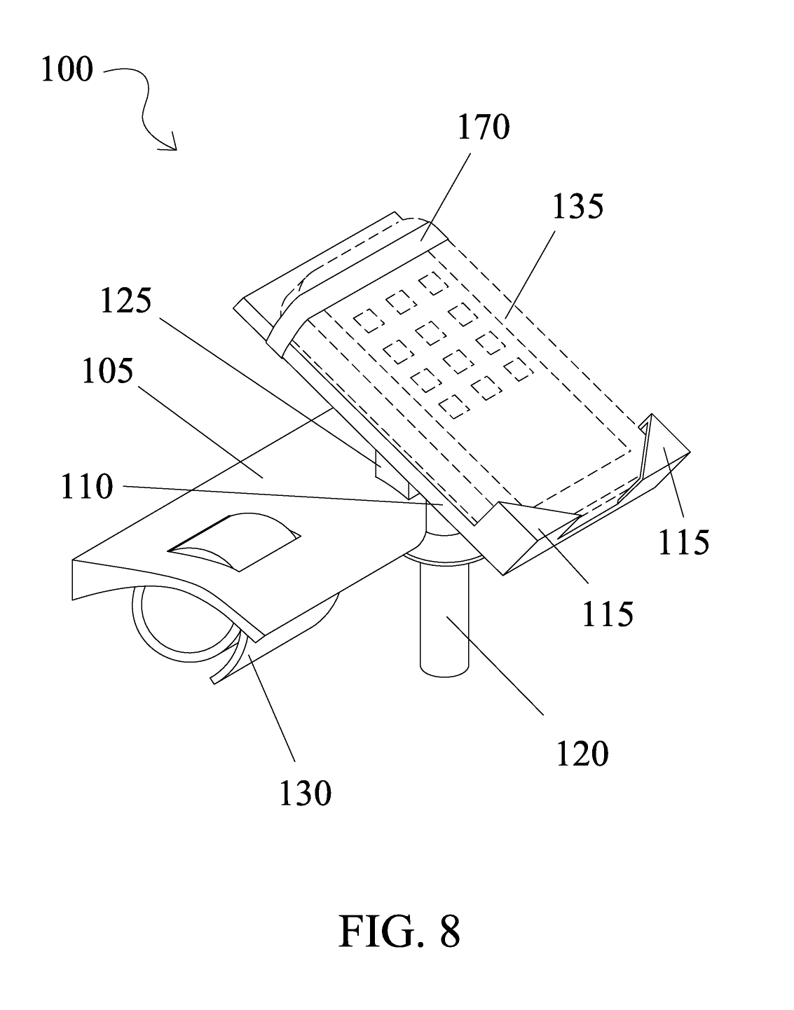

Referring now to FIGS. 2 and 8, a personal media device 135 fits on mounting plate 110 and is removably held in place by corner mounting brackets 115. Corner mounting brackets 115 are made of a resilient rubber-like material that deforms when portable media device 135 is pressed against them. In FIG. 8, a securing strap 170 is used to hold personal media device in place during use. Securing strap 170 is made of an elastic material to allow various size devices to be held securely while in use. Securing strap 170 may also incorporate a hook and loop fastening system (not shown) to allow adjustability. Of course other means may be used to secure personal media device 135 in place such as, but not exclusive to, rotating clips, high-friction surfaces, etc. as long as the device is securely held while in use. This allows a user to interact with personal media device 135 without having to try and hold on to it with their other hand. In one embodiment, forearm mounting portion 105 is covered in a cushioning layer 165 (FIG. 7) to make it more comfortable to the user. Of course, forearm mounting portion may be made of a resilient material without the need for a separate cushioning layer.

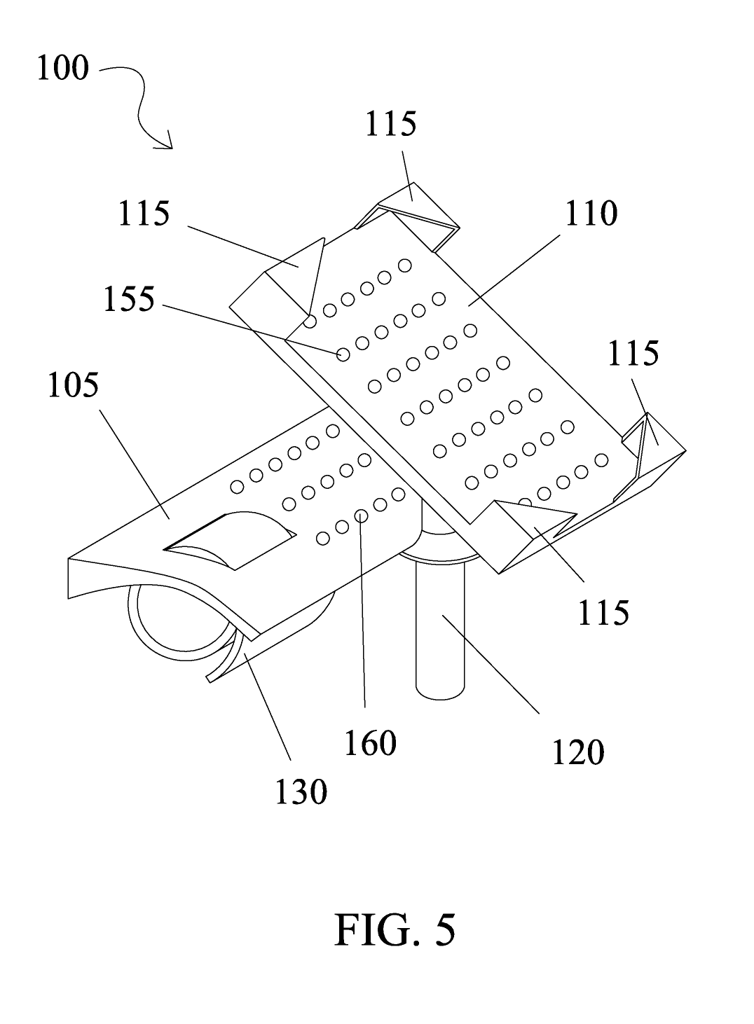

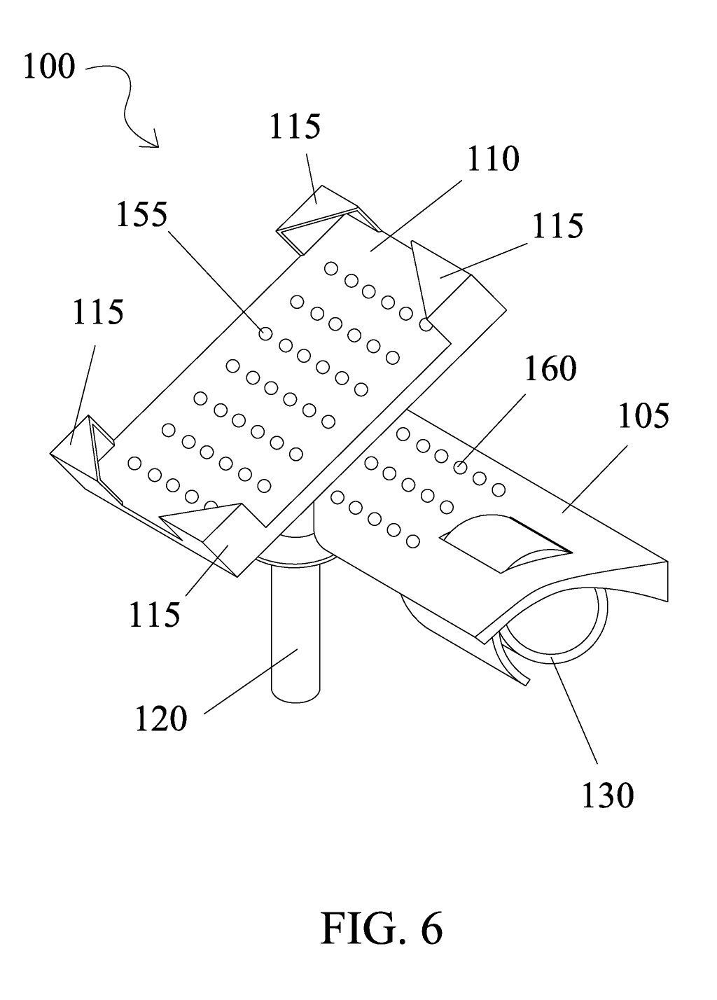

Now referring to FIGS. 5 and 6, portable media device holder 100 is shown having a plurality of mounting plate cooling holes 155 disposed in mounting plate 110 in both the left hand embodiment (FIG. 5) and right hand embodiment (FIG. 6) to allow personal media device 135 to operate at a cooler temperature. Additionally, a plurality of breathing holes 160 are disposed on forearm mounting portion 105 for additional comfort of the user to allow airflow to reach the user's arm.

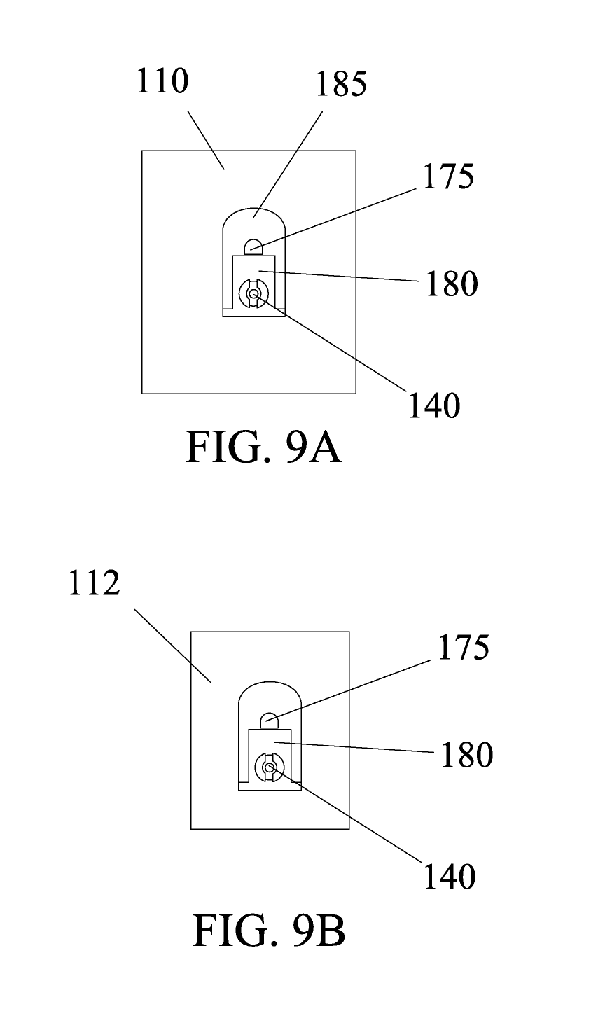

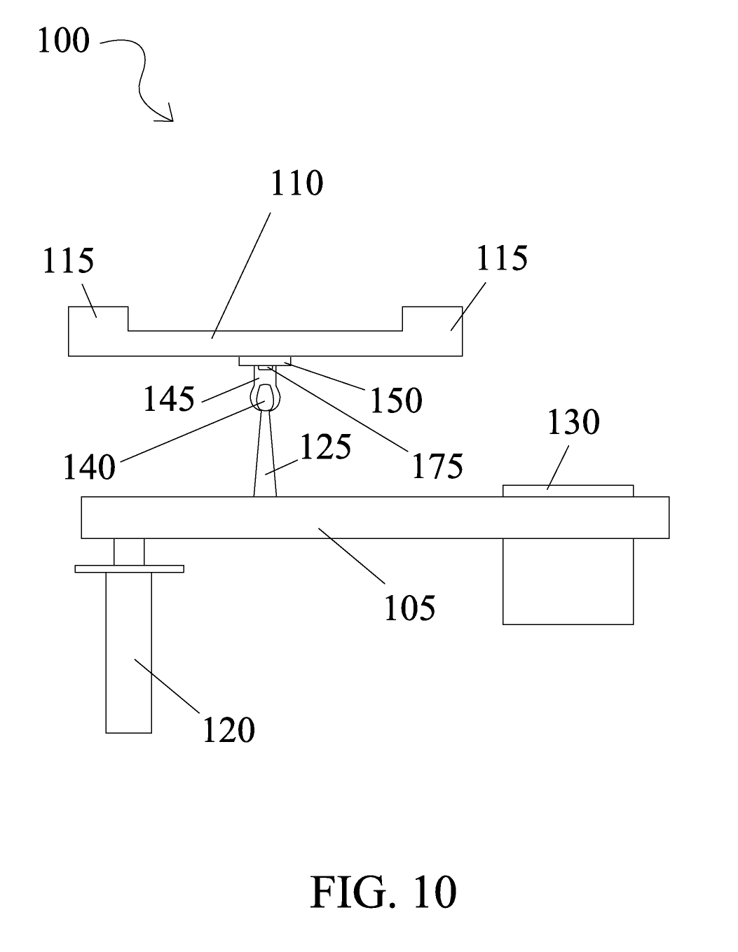

Referring now to FIGS. 9A, 9B and 10, a locking attachment plate 185 is used to allow the user to change out mounting plate 110 for a different size mounting plate 112 to accommodate different size portable media devices. A locking attachment insert 180 removably fits within locking attachment plate 185. A release button 175 is provided to allow the user to release locking attachment insert 180 when pressed. Of course other locking mechanisms may be used as long as the user can change the mounting plate to accommodate different devices.

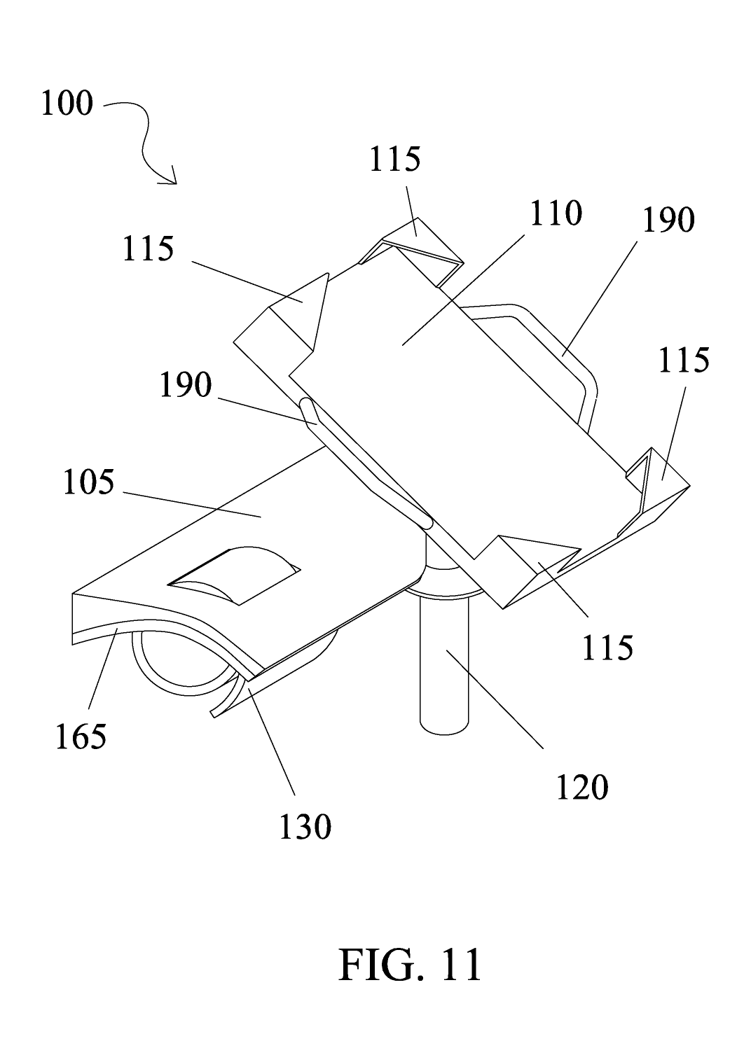

Referring to FIG. 11, mounting plate 110 is shown having positioning handles 190 disposed along the sides of mounting plate 110 so that the user can easily position portable media device 135 (FIG. 8) for the best viewing and input angle. Additionally, in the embodiment shown in FIG. 10 with removable mounting plate 110, positioning handles 190 help the user hold it.

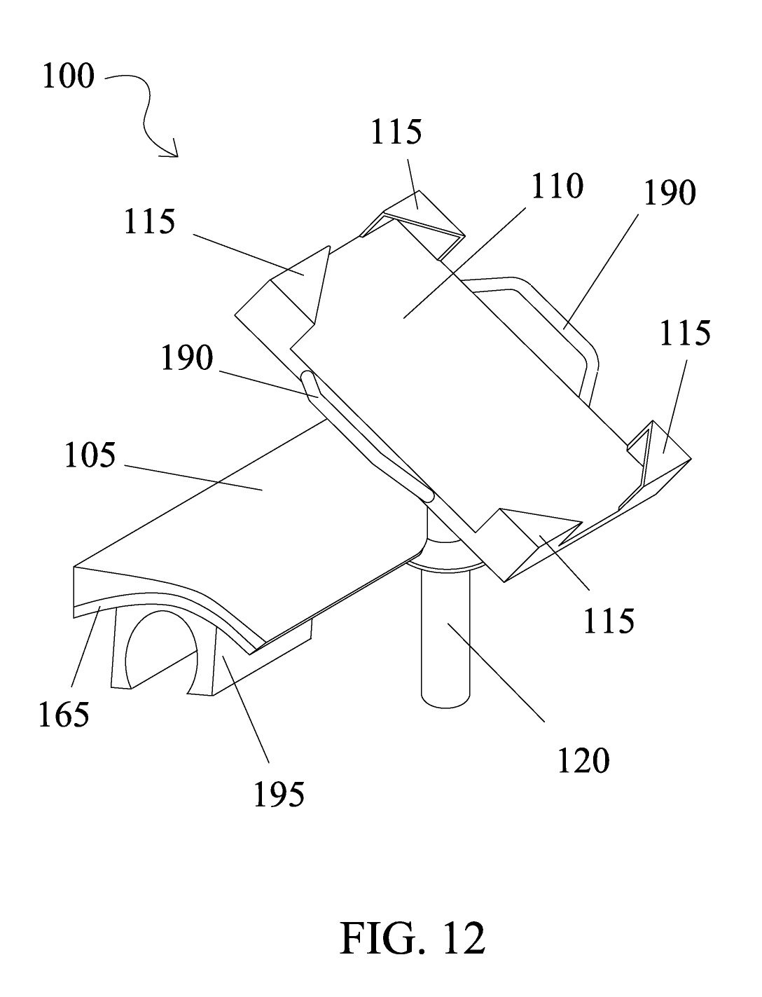

Referring now to FIG. 12, a forearm securing portion 195 is attached to the lower portion of forearm mounting portion 105. Forearm securing portion 195 is made of a resilient material that comfortable fits around the user's forearm to secure the user's forearm therein. Of course other securing methods may be used as long as the user is able to removably secure his or her forearm to the forearm mounting portion 105.

Although the instant invention has been described in relation to particular embodiments thereof, many other variations and modifications and other uses will become apparent to those skilled in the art.

What is claimed is:

1. A portable media device holder comprises:
a mounting plate;
said mounting plate having a device holding means for holding a portable media device on an upper surface therein;
a forearm mounting portion adapted to fit on an upper portion of said user's arm;
a mount pivot post attached between a bottom portion of said mounting plate and on a top portion of said forearm mounting portion;
said mount pivot post having a multi-positional joint disposed therein whereby a user positions said portable media device at a selected viewing angle;
a handle portion projecting downward from a bottom portion of said forearm mounting portion adapted to be held by said user; and
a forearm securing means to removably secure said user's forearm therein.

2. The portable media device holder of claim 1 wherein said device holding means comprises at least two resilient corner mounting brackets adapted to removably hold said portable media device therein.

3. The portable media device holder of claim 1 wherein said device holding means comprises an elastic securing strap adapted to removably hold said portable media device therein.

4. The portable media device holder of claim 1 further comprising at least one positioning handle disposed on a side edge portion of said mounting plate wherein the position of said mounting plate is selected.

5. The portable media device holder of claim 1 wherein said forearm mounting portion has a cushioning portion disposed on a bottom portion.

6. The portable media device holder of claim 1 wherein said arm strap is secured using a hook and loop fastener.

7. The portable media device holder of claim 1 further comprising a plurality of mounting plate cooling holes disposed in said mounting plate.

8. The portable media device holder of claim 1 further comprising a plurality of forearm cooling holes disposed in said forearm mounting portion.

9. The portable media device holder of claim 7 further comprising a plurality of forearm cooling holes disposed in said forearm mounting portion.

10. The portable media device holder of claim 1 further comprising a locking attachment means for removably securing said mounting plate to said mount pivot post.

11. The portable media device holder of claim 10 whereby said locking attachment means comprises:
a locking mechanism having locking attachment insert being adapted to removably fit within an attachment plate;
said attachment place being disposed on a bottom portion of said mounting plate;
a release disposed on said attachment plate whereby said locking attachment insert is released when said release is depressed.

12. The portable media device holder of claim 1 whereby said multi-positional joint is a ball joint.

13. The portable media device holder of claim 1 whereby said forearm securing means comprises an arm strap adapted to releasably hold said user's forearm to said forearm mounting portion.

14. The portable media device holder of claim 1 whereby said forearm securing means comprises a forearm securing portion mounted to a lower portion of said forearm mounting portion.

15. The portable media device holder of claim 14 wherein said forearm securing portion is made of a resilient material.
